(19) United States
(12) Patent Application Publication
(10) Pub. No.: US 2008/0191459 A1
(43) Pub. Date: Aug. 14, 2008

(54) Easily turned child's book

(75) Inventor: Lucy Schultz, Granger, IN (US)

Correspondence Address: Alan B. Clement;Locke Lord Bissell & Liddell LLP, 885 Third Avenue, 26th Floor, New York, NY, 10022, US

(73) Assignee: Innovative USA, Inc.

(21) Appl. No.: 11/704,463

(22) Filed: Feb. 9, 2007

(51) Int. Cl. B42D 1/00

(52) U.S. Cl. 281/15.1

(57) ABSTRACT

A book designed to allow children or other people with limited motor skills to be able to easily turn the pages within the book. The book comprises a front cover, a back cover, and one or more pages. Each page has a graspable tab located on one of its edges, which extends past the tabs that are located on subsequent pages. The tabs can be in a variety of shapes.

### FIELD OF THE INVENTION

The present invention relates to a book that has pages that easily are turned by a young child, a handicapped individual, or anyone else with limited manual dexterity. More particularly, the present invention relates to a book wherein the edges of the pages are cut into various shapes in order to facilitate gripping one page at a time. Most particularly, the present invention is related to a book wherein the pages are composed of cardboard or other stiff material and the edges of the pages are cut into various shapes in order to facilitate gripping one page at a time.

### BACKGROUND OF THE INVENTION

Books have been marketed for many years with a basically standard format: the edges of all the pages within a book line up with each other on three sides and are bound together in some fashion on the fourth side. This format is utilized easily by most adults and teenagers, however very young children and other people with various physical disabilities may find it very difficult to flip from one page to the next. For example, because all the page edges are lined up, it can be difficult to grip just one page at a time. Additionally, paper pages can have a tendency to stick to each other, thus causing further difficulties. A variety of books are currently on the market that seek to facilitate the flipping of pages, in order to make reading a more desirable activity for children and others.

For example, U.S. Pat. No. 5,328,206 to Scott teaches an improved stiff-paged board book using spacing structures between adjacent leaves to form small gaps which provided convenient finger holds that facilitate turning of individual pages by young children. However, these spacing structures cause the book to be bulkier than the number of pages would otherwise require. Additionally, the spacing structures take up page space that otherwise could be useful for additional words or pictures.

U.S. Pat. No. 4,756,556 to Ader et al. discloses a book structure wherein each leaf of the book is of a rigid plastic construction with projections above and below the plane of the leaf for holding printed matter on cards. The projections also serve as spacers to separate the pages from each other. Furthermore, each page has rigid tab projections to serve as handles. Here, again, the spacers cause the book to be bulkier than the number of pages would otherwise require. Furthermore, the book is very wasteful in that the actual leaf of the book is separate from each page, so two structures are needed instead of just one.

U.S. Pat. No. 4,280,241 to Pfaff teaches a book with just a few leaves, the leaves being soft and thick and made by inserting foam plastic or rubber into pockets of material. This book suffers from the same problem as the previously mentioned books insofar as the pages must be exceedingly thick: the Pfaff patent envisions the use of pages that are a half inch thick in order to allow children to readily grasp and turn the pages. The book also is limited to approximately five leaves, due to size constraints.

Other patents seek to facilitate a user's ease in finding a particular place in a book, for example, locating where the letter “G” begins in a dictionary. U.S. Pat. No. 283,383 to Dé Silv\tilde{e}ra discloses a book with concave niches cut into the edges of its leaves, with the index characters placed upon the concave walls of the niches. However, this would only help a user find a particular section rather than a particular page. Additionally, the edges of the pages still would be uniform within each section, thereby impeding attempts to flip one page at a time.

U.S. Pat. No. 306,218 to Butler teaches a book having segmental recesses cut obliquely into the edges of pages. This book suffers from the same flaw as the Dé Silv\tilde{e}ra book in that it only helps with finding a particular place in a book, for example, locating where the letter “G” begins in a dictionary. Again, this only would help a user find a particular section rather than a particular page. Thus, the edges of the pages still would be uniform within each section, thereby impeding attempts to flip one page at a time.

U.S. Pat. No. 511,339 to Livesey discloses an accounting-type book that is produced by cutting a slip out of the side of each page of the book, of the same shape or form, so that when each page has been cut, a small part of each page will overlap or project beyond all the leaves beneath it. However, this is useful only in helping adults find a specific page; nothing about this patent teaches or discloses a way of making it easier to flip pages—there is nothing taught that would enable a child to easily grip something on the page in order to flip that page.

U.S. Pat. No. 1,404,541 to Parsons suffers from a problem similar to the Livesey patent in that the invention allows a user to see where one page ends and the next begins, however nothing in the patent makes it easier to grip and flip a page.

U.S. Pat. No. 1,311,733 to Wilmot suffers from the same problems as the Parsons and Livesey patents in that, while specific pages can easily be found, the manner in which the pages are marked still would render it difficult for a child to grasp and turn each page.

U.S. Pat. No. 648,476 to Wiley teaches the use of tags to distinguish between different sections of an index that holds loose-leaf pages. However, the tags as described by Wiley are too close to each other and are too small to be grasped easily by a child.

Accordingly, it would represent an advancement in the art of children's books if there were a book design which would allow a child to grasp easily a page, turn the page, and continue to read the book without experiencing difficulty in manipulating the pages.

### SUMMARY OF THE INVENTION

It is therefore an object of the present invention to provide a book that facilitates the turning of the pages by a child, so that the child easily can read the pages sequentially.

It is a further object of the present invention to provide a book that a child easily can manipulate and that is not overly thick, which may cause apprehension in children who are averse to long books.

It is a further object of the present invention to provide a child's book with no additional spaces between pages, which can take up extra room on a merchant's shelf.

It is a further object of the present invention to provide an easily turned child's book that does not incorporate separate pieces, which can pose a choking hazard to young children.

It is a further object of the present invention to provide a book that facilitates the turning of the pages by a person of limited motor skills, so that person easily can read the pages sequentially.

It is a further object of the present invention to provide a book that a person with limited motor skills can manipulate, the book having no additional spaces between pages, which can take up extra room on a merchant's shelf.

Accordingly, these objects and others are achieved by the book of the present invention, which comprises a book wherein at least one unbound edge of each page in the book is cut into a shape that allows a child or other person of limited motor skills to easily grasp, and turn, the page.

In preferred embodiments, the edge is located opposite the bound edge and the cutout is rounded or curvy to aesthetically please and to make the book minimize any sharp angles that might injure a child.

### BRIEF DESCRIPTION OF THE DRAWINGS

FIG. 1 depicts a top view of the opened cover of the book in the preferred embodiment.

FIG. 2 depicts a top view of the first leaf (pages 1 and 2) of the book in the preferred embodiment.

FIG. 3 depicts a top view of the first leaf (pages 3 and 4) of the book in the preferred embodiment.

FIG. 4 depicts a top view of the first leaf (pages 5 and 6) of the book in the preferred embodiment.

FIG. 5 depicts a top view of the first leaf (pages 7 and 8) of the book in the preferred embodiment.

FIG. 6 depicts a top view of the first leaf (pages 9 and 10) of the book in the preferred embodiment.

FIG. 7 depicts a top view of the first leaf (pages 11 and 12) of the book in the preferred embodiment.

FIG. 8 depicts a frontal view of the book in a slightly opened position in the preferred embodiment.

### DETAILED DESCRIPTION OF THE PRESENT INVENTION

The following description of preferred embodiments is presented to illustrate the present invention and is not to be construed to limit the scope of the appended claims in any manner whatsoever.

As best shown in FIG. 1, the first leaf (11) of the book is composed of a front cover (15) and a back cover (16) that are joined together at the spine (12). When the book is in a closed position, the tab (13) extends past all subsequent pages (not shown). The reverse side of the front cover (15) is attached to the reverse side of the first page of the book, and the reverse side of the back cover (16) is attached to the reverse side of the twelfth page (75) of the book (see FIG. 7).

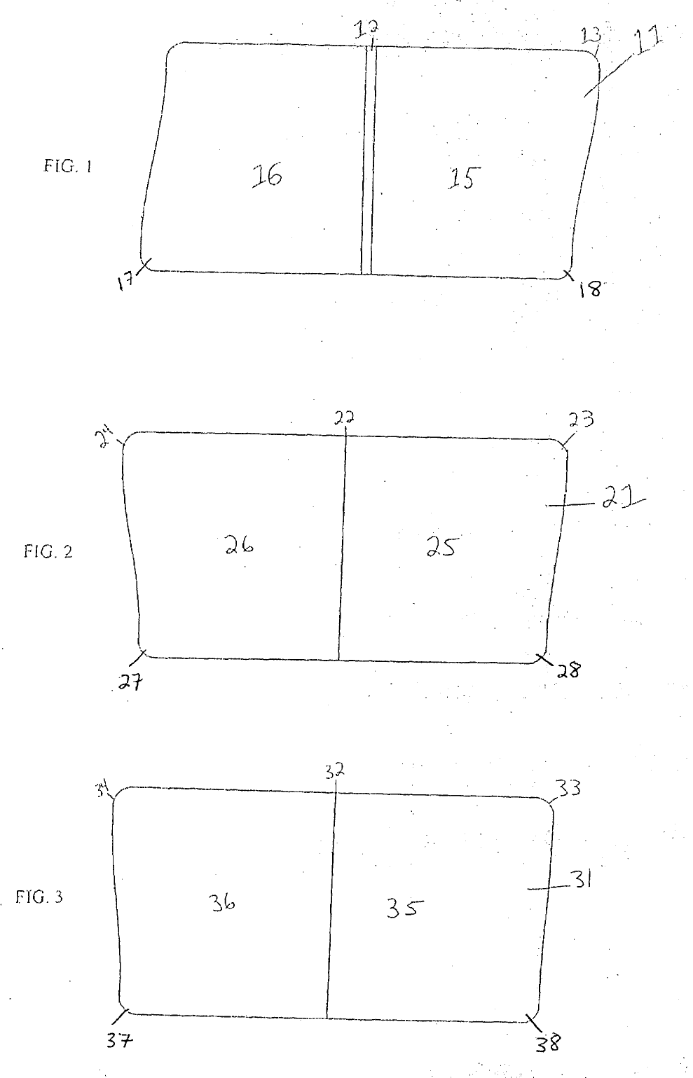

As best shown in FIG. 2, the second leaf (21) of the book is composed of the first page (26) in the book and the second page (25) in the book. The first page (26) and the second page (25) are connected at the midpoint (22) which is folded. The reverse side of the first page (26) is attached to the reverse side of the front cover (15) (see FIG. 1). When the book is in a closed position, the tab (23) extends past all subsequent pages (not shown), and the tab (28) extends past all previous pages (not shown). The tab (24) is lined up exactly with the tab (13) on the front cover (15) (see FIG. 1), and the tab (28) is lined up exactly with the tab (37) on the third page (36) (see FIG. 3). The reverse side of the second page (25) is attached to the reverse side of the third page (36) (see FIG. 3).

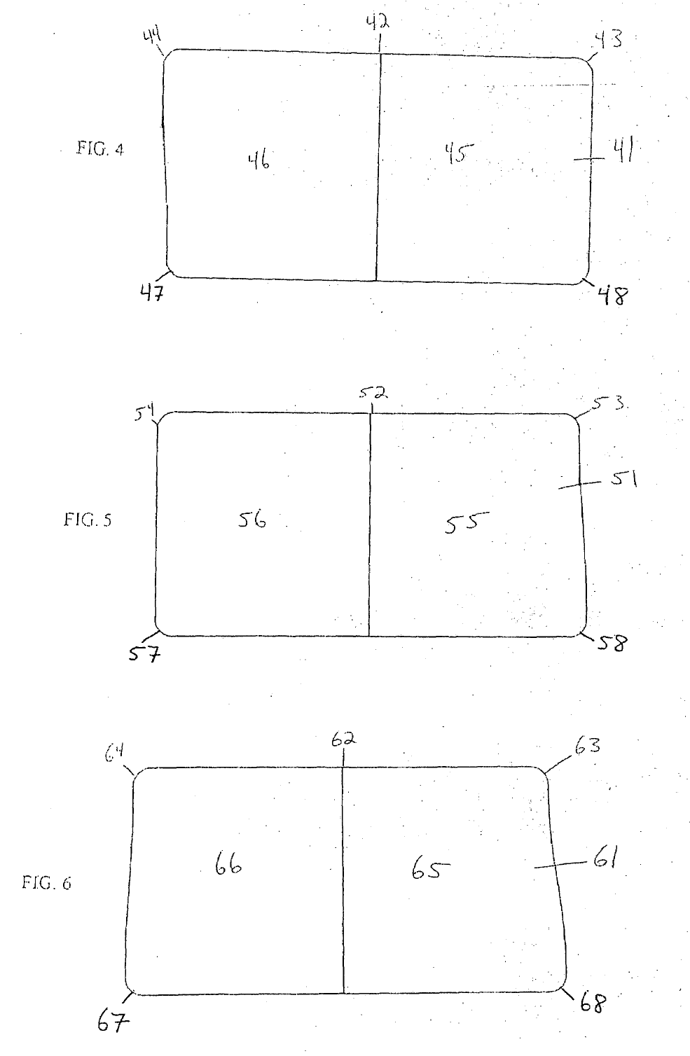

As best shown in FIG. 3, the third leaf (31) of the book is composed of the third page (36) in the book and the fourth page (35) in the book. The third page (36) and the fourth page (35) are connected at the midpoint (32) which is folded. The reverse side of the third page (36) is attached to the reverse side of the second page (25) (see FIG. 2). When the book is in a closed position, the tab (33) extends past all subsequent pages (not shown), and the tab (38) extends past all previous pages (not shown). The tab (34) is lined up exactly with the tab (23) on the second page (25) (see FIG. 2), and the tab (38) is lined up exactly with the tab (47) on the fifth page (46) (see FIG. 4). The reverse side of the fourth page (35) is attached to the reverse side of the fifth page (46) (see FIG. 4).

As best shown in FIG. 4, the third leaf (41) of the book is composed of the fifth page (46) in the book and the sixth page (45) in the book. The fifth page (46) and the sixth page (45) are connected at the midpoint (42) which is folded. The reverse side of the fifth page (46) is attached to the reverse side of the fourth page (35) (see FIG. 3). When the book is in a closed position, the tab (43) extends past all subsequent pages (not shown), and the tab (48) extends past all previous pages (not shown). The tab (44) is lined up exactly with the tab (33) on the fourth page (35) (see FIG. 3), and the tab (48) is lined up exactly with the tab (57) on the seventh page (56) (see FIG. 5). The reverse side of the sixth page (45) is attached to the reverse side of the seventh page (56) (see FIG. 5).

As best shown in FIG. 5, the fourth leaf (51) of the book is composed of the seventh page (56) in the book and the eighth page (55) in the book. The seventh page (56) and the eighth page (55) are connected at the midpoint (52) which is folded. The reverse side of the seventh page (56) is attached to the reverse side of the sixth page (45) (see FIG. 4). When the book is in a closed position, the tab (53) extends past all subsequent pages (not shown), and the tab (58) extends past all previous pages (not shown). The tab (54) is lined up exactly with the tab (43) on the sixth page (45) (see FIG. 4), and the tab (58) is lined up exactly with the tab (67) on the ninth page (66) (see FIG. 6). The reverse side of the eighth page (55) is attached to the reverse side of the ninth page (66) (see FIG. 6).

As best shown in FIG. 6, the fifth leaf (61) of the book is composed of the ninth page (66) in the book and the tenth page (65) in the book. The ninth page (66) and the tenth page (65) are connected at the midpoint (62) which is folded. The reverse side of the ninth page (66) is attached to the reverse side of the eighth page (55) (see FIG. 5). When the book is in a closed position, the tab (63) extends past all subsequent pages (not shown), and the tab (68) extends past all previous pages (not shown). The tab (64) is lined up exactly with the tab (53) on the eighth page (55) (see FIG. 5), and the tab (68) is lined up exactly with the tab (77) on the eleventh page (76) (see FIG. 7). The reverse side of the tenth page (65) is attached to the reverse side of the eleventh page (76) (see FIG. 7).

As best shown in FIG. 7, the sixth leaf (71) of the book is composed of the eleventh page (76) in the book and the twelfth page (75) in the book. The eleventh page (76) and the twelfth page (75) are connected at the midpoint (72) which is folded. The reverse side of the eleventh page (76) is attached to the reverse side of the tenth page (65) (see FIG. 6). When the book is in a closed position, the tab (73) extends past all subsequent pages (not shown), and the tab (78) extends past all previous pages (not shown). The tab (74) is lined up exactly with the tab (63) on the tenth page (65) (see FIG. 6), and the tab (78) is lined up exactly with the tab (17) on the back cover (16) (see FIG. 1). The reverse side of the twelfth page (75) is attached to the reverse side of the back cover (16) (see FIG. 1).

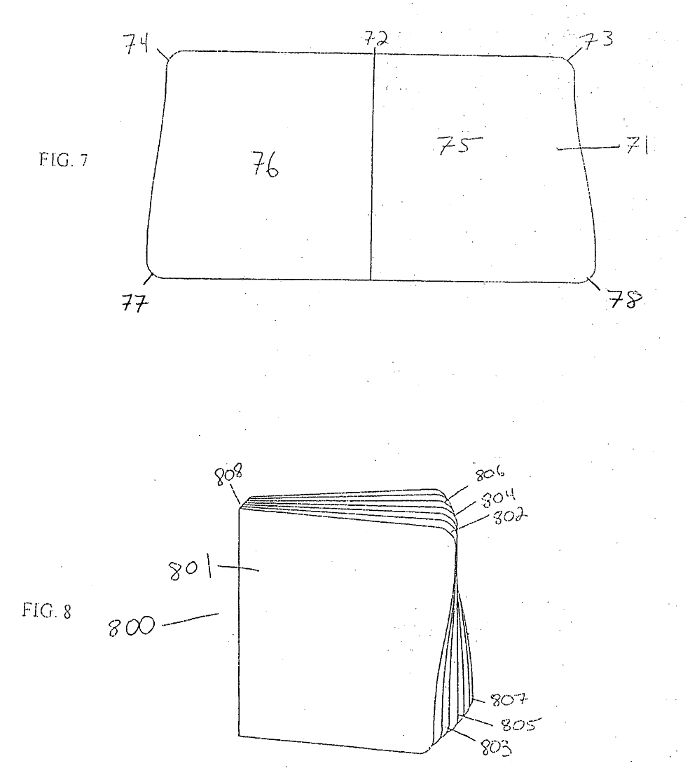

As best shown in FIG. 8, the finished book (800) is composed of seven leaves (801, 802, 803, 804, 805, 806, 807) that are attached at a spine (808). The first leaf (801) forms the front cover and back cover of the finished book (800). Each of the other leaves (802, 803, 804, 805, 806, 807) each form two pages of the finished book (800).

The reverse of each page that is attached to the reverse of another page, or to a cover, can be attached using any attachment method known. This includes, but is not limited to, glue, tape, adhesive, magnets, ties, epoxy, cement, paste, fasteners, Velcro, gums, and solder. The pages and leaves of the book can be composed of any type of material upon which indicia can be printed or written, however it is preferred that the pages be made out of a heavy paper cardstock or cardboard, to reduce the risk of “paper cuts” or other injury. The tabs on each page can be in any shape and/or any position that is easily grasped by a child but each tab should be smooth. However, for safety reasons it is preferred that the tabs be somewhat curved or rounded as shown in the attached figures. It is also possible that the tabs be in the shape of well-known childhood figures (e.g., Santa Claus, the Easter Bunny, various cartoon characters, etc.), letters, numbers, or any other fanciful design that would function as a tab. It is envisioned that any number of pages can be used with this invention but each page should have a tab to enable a child to easily reach that page. The book may be bound in any way known to be effective as a book binding.

When in a closed position, the book should be substantially flat with no extra spaces between pages. However, it is envisioned that depressions may be placed into each page to help a child grasp the page. For example, if a page is ¼ inch thick, then a depression ⅛ inch deep can be impressed into the page as this will not change the thickness of the book. There should be no pieces that could possibly break off from the book and pose a choking or other hazard.

Having described the present invention, it will now be apparent that many changes and modifications may be made to the above-described embodiments without departing from the spirit and the scope of the present invention.

The above-mentioned patents are hereby incorporated by reference.

1. A book comprising a front cover, a back cover, and one or more pages, each page having a first graspable tab located on an edge of said page, said first tab extending past other tabs located on subsequent pages.

2. The book of claim 1 further comprising a second graspable tab located on an edge of said page, said second tab extending past other tabs located on previous pages.

3. The book of claim 1 wherein said front cover, said back cover, and said pages of said book are formed from one or more materials selected from the group consisting of paper, cardboard, cardstock, foams, plastics, rubbers, metal, wood, polymers, and cloth.

4. The book of claim 1 wherein said first and/or second tabs are rounded.

5. The book of claim 1 wherein said first and/or second tabs are rectangular.

6. The book of claim 1 wherein said first and/or second tabs are triangular.

7. The book of claim 1 wherein said first and/or second tabs are in the shape of one or more figures selected from the group consisting of Santa Claus, the Easter Bunny, cartoon characters, literary characters, computer game characters, and video game characters.

8. The book of claim 1 wherein said first and/or second tabs are located on an edge opposite the spine of said book.

9. The book of claim 1 wherein said first and/or second tabs are located on an edge adjacent to the spine of said book.

10. The book of claim 1 wherein said first and/or second tabs are in the shape of letters.

11. The book of claim 1 wherein said first and/or second tabs are in the shape of numbers.

12. The book of claim 1 wherein said first and/or second tabs are in the shape of fanciful designs.

13. The book of claim 1 wherein one or more pages each have at least one depression pressed into at least one face of said page.

14. The book of claim 13 wherein said page is as thick or thicker than said depression.

15. A book comprising:
a. a front cover,
b. a back cover, and
c. one or more pages,
said front cover, said back cover, and said one or more pages being made of cardboard, wherein each page has
a. a first graspable tab located on an upper edge of said page, said first tab extending past other tabs located on subsequent pages, and
b. a second graspable tab located on a lower edge of said page, said second tab extending past other tabs located on previous pages,
said first tab and said second tab on each of said one or more pages being connected to form a curvature.

16. A book comprising a front cover, a back cover; and one or more pages,
a. wherein each page has
i. a first graspable tab located on an edge of said page, said first tab extending past other tabs located on subsequent pages;
ii. a second graspable tab located on an edge of said page, said second tab extending past other tabs located on previous pages; and
b. wherein said first and/or second tabs are:
i. located on an edge opposite or adjacent to the spine of said book and
ii. said first and/or second tabs are in a shape selected from the group consisting of rounded shapes, rectangular shapes, triangular shapes, Santa Claus shapes, Easter Bunny shapes, cartoon characters, literary characters, computer game characters, video game characters, letters, numbers, numerals and fanciful designs,
c. wherein said front cover, said back cover, and said pages of said book are formed from one or more materials selected from the group consisting of paper, cardboard, cardstock, foams, plastics, rubbers, metal, wood, polymers, and cloth; and, optionally,
d. wherein
i. one or more pages of said book each have at least one depression pressed into at least one face of said page, and
ii. said page is as thick or thicker than said depression.

17. A book comprising a front cover, a back cover, and one or more pages,
a. wherein each page has
i. a first graspable tab located on an edge of said page, and
ii. a second graspable tab located on an edge of said page; and
b. wherein
i. said first graspable tab extends past other tabs located on subsequent pages, and
ii. said second tab extends past other tabs located on previous pages; and
c. wherein one or more pages of said book each have at least one depression pressed into at least one face of said page, and said page is as thick or thicker than said depression.
